(19) United States
(12) Patent Application Publication
(10) Pub. No.: US 2012/0038890 A1
(43) Pub. Date: Feb. 16, 2012

(54) Illuminated device possessing a floating image

(75) Inventors: Ching-Cherng Sun, Jhongli City (TW); Ching-Yi Chen, Jhongli City (TW)

(73) Assignee: National Central University (a university of Taiwan)

(21) Appl. No.: 13/069,484

(22) Filed: Mar. 23, 2011

(30) Foreign Application Priority Data
Aug. 13, 2010 (TW) 099127186

(51) Int. Cl. G03B 21/28

(52) U.S. Cl. 353/10

(57) ABSTRACT

An illumination device capable of producing a floating image which includes a light emitting module installed at a central position of a reflecting cavity. An object is placed on the light emitting module and a light reflector is placed at the opening of the reflecting cavity, a hole is located at a central position of the light reflector, corresponding to the light emitting module and the object. A power supply module for supplying an electric power to the light emitting module for generating a light source, so that the light source can be projected and passed through the object, and an image of the object is reflected from the light reflector to the mirror of the reflecting cavity, and then reflected from the mirror to the hole where the light is focused to form a floating image with a shape identical to the object, so as to achieve the effects of illumination and forming a floating live image.

### BACKGROUND OF THE INVENTION

1. Field of the Invention

This invention relates to a kind of illuminated device which possesses a floating image. Specifically, a kind of illuminated device which can simultaneously provide illumination and a floating image.

2. Description of Related Art

A decorative item constructed of a cavity 11, another cavity 12 and a transparent object (as shown in FIG. 6). Located in the middle of cavity's 11 and 12, each has a hole 111 and 121. On the inside sides of cavity's 11 and 12, are mirrored sides 112 and 122.

The transparent object 13 is placed on top of the hole in cavity 11, the cavity hole having a diameter slightly smaller than the diameter of transparent object 13. When the second cavity 12 closes on top of cavity 11, it results in mirrors 122 and 112 reflecting corresponding images.

When an external light source 2 is shone through the other hole 121 into the interior of the decorative item and illuminates the transparent object 13, this illuminated image 13 utilizes the mirror image principle to be projected from mirror 122 to mirror 112. After being reflected onto mirror 112, the image will be focused onto the other hole 121, resulting in hole 121 forming a floating image 131 identical to the transparent object 13 (as shown in FIG. 7).

Since this decorative item's floating image is formed by projecting an external light source 2 into the decorative item, there are certain drawbacks caused when changes in the external light source (such as interference) cause the light to become insufficiently strong. This interference results in the image of the transparent object 13 failing to adhere to the mirror image principle, thus being unable to focus on the hole 121 and form the floating image 131. This is the first drawback. In addition, the second cavity 12 of the present existing decorative item is a non-transparent structure with the second mirror 122, resulting in this decorative item being unable to be used as a device which projects light. This is the second drawback. Furthermore, this decorative item is solely for decorative use and unable to provide additional functions, such as an ON/OFF timer, rotation of the floating real image 131 and wireless controls, etc. This is the third drawback.

Therefore, how to provide an illuminated device simultaneously capable of projecting light and displaying a floating image, is a subject for industry to solve.

### SUMMARY OF THE INVENTION

It is a device capable of providing illumination and a floating image. A light emitting module is set in the centre of a reflective cavity and an object is placed on the light emitting module, a light reflector is placed at the opening of the reflective cavity, and a hole is located in the center of this lamp reflector, resulting in the hole, the light emitting module and the object all corresponding. The light reflector and the reflective surface in the cavity are facing each other. When a power supply module connected to the light emitting module is turned on, the light source shines onto and through the object, and the image from this object is reflected from the lamp reflector onto the mirror in the cavity, where the image is reflected to the hole, resulting in a focused form which is a floating image identical to the object. Thereby ultimately reaching the goal of being simultaneously illuminated and showing a floating image.

To achieve the abovementioned objective, the present invention adopts the following technical measures. An opening is set at one end of a reflective cavity, the inside has a mirrored surface, located in the centre of this reflective cavity is a light emitting module for producing light An object is placed on the light emitting module, a light reflector is placed at the opening of this reflective cavity and the two mirrored surfaces in the cavities face each other. A hole is located in the centre of the light reflector which corresponds to the light emitting module and the object. A power supply module is provided for supplying electric power to the light emitting module to generate the light source.

### BRIEF DESCRIPTION OF THE DRAWINGS

The invention, as well as its many advantages, may be further understood by the following detailed description and drawings in which:

FIG. 1 is an exploded view of an illumination device capable of producing a floating image in accordance with a first preferred embodiment of the present invention;

FIG. 2 is a first cross-sectional view of an illumination device capable of producing a floating image in accordance with a first preferred embodiment of the present invention;

FIG. 3 is a second cross-sectional view of an illumination device capable of producing a floating image in accordance with a first preferred embodiment of the present invention;

FIG. 4 is a schematic view of an illumination device capable of producing a floating image in accordance with a first preferred embodiment of the present invention;

FIG. 5 is an exploded view of an illumination device capable of producing a floating image in accordance with a second preferred embodiment of the present invention;

FIG. 6 is an exploded view of a conventional decorative item; and

FIG. 7 is a cross-sectional view of a conventional decorative item.

### DETAILED DESCRIPTION OF THE INVENTION

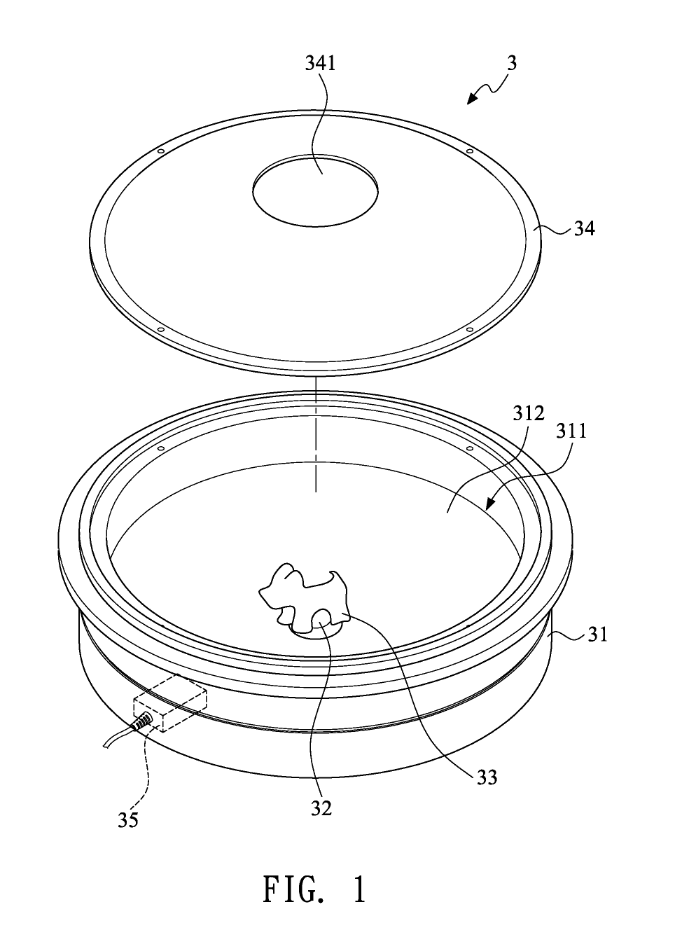

With reference to FIGS. 1 to 4 for an illumination device capable of producing a floating image in accordance with a first preferred embodiment of the present invention, the illumination device 3 comprises a reflective cavity 31, a light emitting module 32, an object 33, a light reflector 34 and a power supply module 35.

An opening 311 is set at the end of the reflective cavity 31, the inside of which has a mirrored surface 312. The light emitting module 32 is installed at a central position in the reflective cavity 31 for generating a light source 4. The object 33 is placed on the light emitting module 32. The light reflector 34 is located at the opening 311 of the reflective cavity 31, such that the light reflector 34 is arranged opposite and facing the mirror 312 of the reflective cavity 31. A hole 341 is located at a central position of the light reflector 34 and corresponds to the light emitting module 32 and the object 33. Finally the power supply module 35 is provided for supplying electric power to the light emitting module 32 to generate the light source 4.

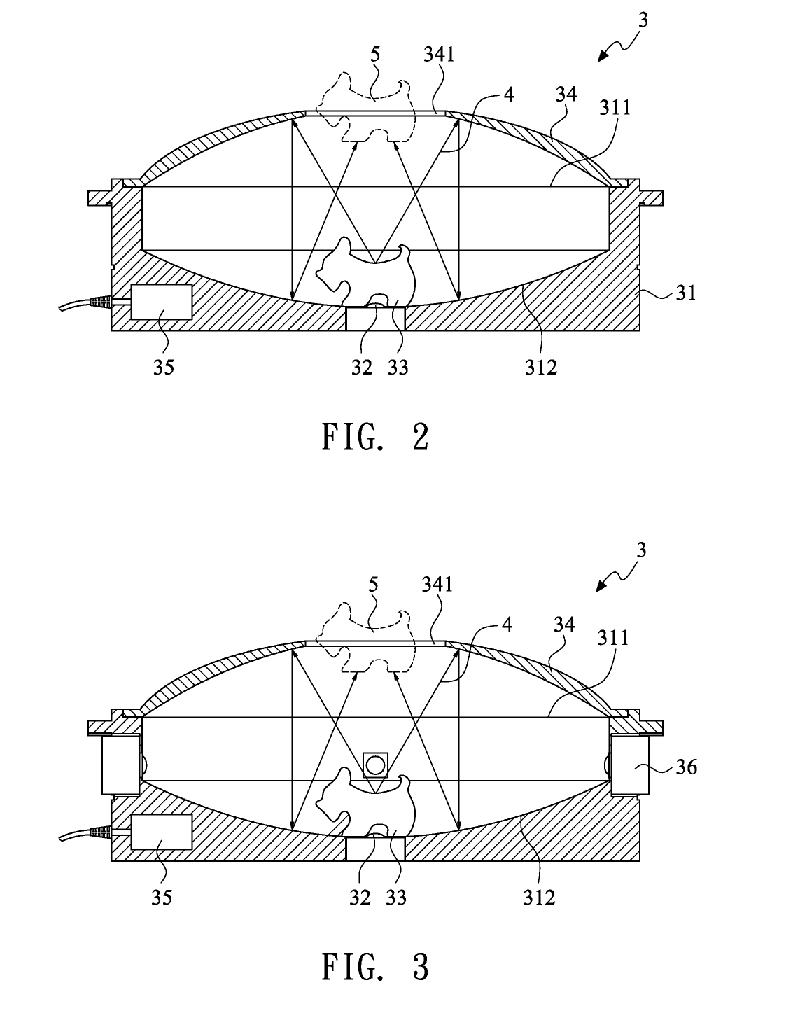

The power supply module 35 is installed in the reflective cavity 31 (as shown in FIGS. 1 and 2). It is connected to an external power source (as shown in FIG. 4) for supplying the electric power to the light emitting module 32 to operate the illumination device 3.

The light emitting module 32 can be a monochrome LED element or a three-color LED element, so that the illumination device 3 can have diversified light sources. Unlike conventional decorative items, the illumination device 3 of this invention not only provides a monochrome light source but also a multi-color light source.

The object 33 can be a transparent object or a semi-transparent object. When the light source 4 projects onto the object 33, it can refract through the object 33, letting the level of brightness from the light source show different brightness levels.

The light reflector 34 can be semi-transparent or transparent. It has a smooth internal surface. This smooth internal surface can be constructed in a choice of a parabolic, non-spherical or a flat shape. Reflecting the light source off these different surfaces maximizes the effectiveness of the projection from the light source.

Mirrored surfaces 312 can be constructed to be parabolic, non-spherical or flat. These different surfaces allow the light source 4 to be reflected from the light reflector 34 to the hole 341 more effectively, thereby focusing into the form of a floating image 5, which is identical to the image of object 33 (as shown in FIG. 2).

Object 33 is placed on the light emitting module 32. Light reflector 34 is installed at the opening 311 of the reflective cavity 31, thereby light reflector 34 and the reflective cavity 31 are opposite and facing. The power supply module 35 is provided for supplying the electric power to the light emitting module 32 to generate the light source 4.

When the light source 4 is shone through from the bottom of the object 33, (as shown in FIG. 2), and the light is refracted through the object 33, the light source 4 will project onto the light reflector 34, the light reflector 34 then reflecting onto the mirrored surface 312 of cavity 31. Finally the mirrored surface 312 will reflect light source 4, resulting in light source 4 focusing on hole 341, thus forming a floating object 5 identical to object 33.

The floating image 5 is produced by placing the transparent or semi-transparent object 33 on the light emitting module 32 which is situated at a central position in the reflective cavity 3. The power supply module 35 is provided for supplying the electric power to the light emitting module 32 to generate the light source 4, such that the light source 4 is projected and passed through the object 33 to produce an image of the object 33. The light source 4 is further reflected from the lamp reflector 34 to the mirror 312 of the reflective cavity 31, and then from the mirror 312 to the hole 341. Finally, the light source 4 is focused at the hole 341 to form the floating image 5 which has a shape identical to the object 33.

The light emitting module 32 can be designed with a function to rotate. During operation of the illumination device 3, the light emitting module 32 rotates axially to drive and rotate the object 33, such that the floating image 5 focused and formed at the hole 341 can rotate accordingly.

In addition to the formation of the floating image 5 by the light source 4, the illumination device also can serve as a mini night lamp by using the light source 4 of the light emitting module 32.

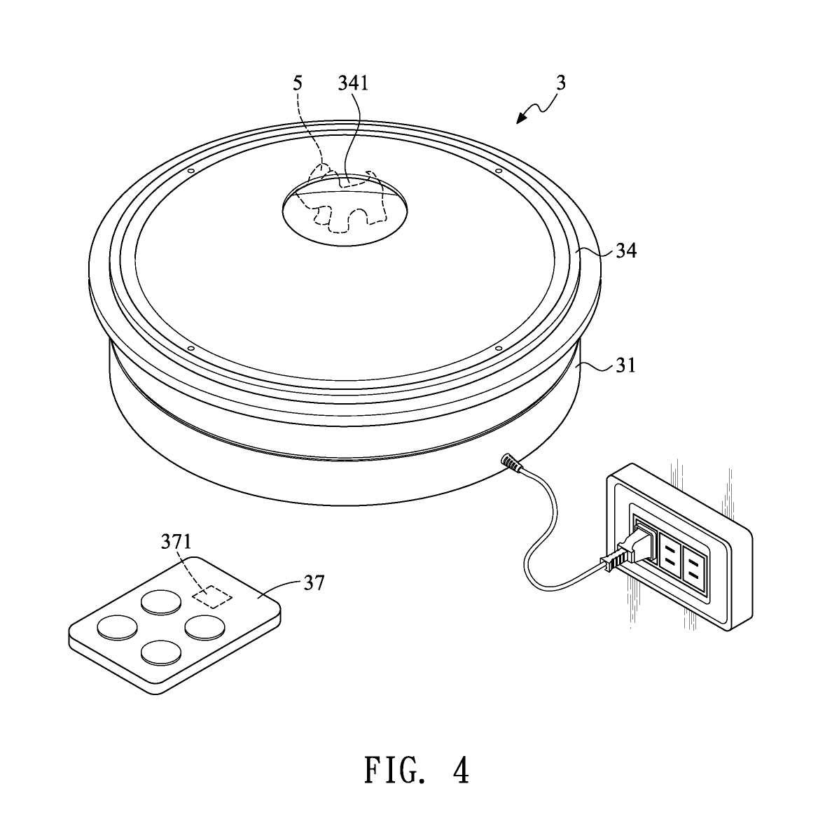

In addition, by adding multiple light emitting modules 36 around the reflective cavity 31 of the illumination device 3 (as shown in FIG. 3), the brightness level of the illumination device 3 can be increased, enabling the illumination device to not only have a floating image, but also to be used as a lamp for illumination. The illumination device 3 further includes: a remote control module 37 with a control unit 371 installed therein for controlling a timer to turn the illumination device 3 on or off. This control module also controls axial rotation, frequency of blinking, the color temperature level, the illumination brightness as well as music playback. The colors indicating the color temperature of the light emitting module 32 is composed of white and amber colors.

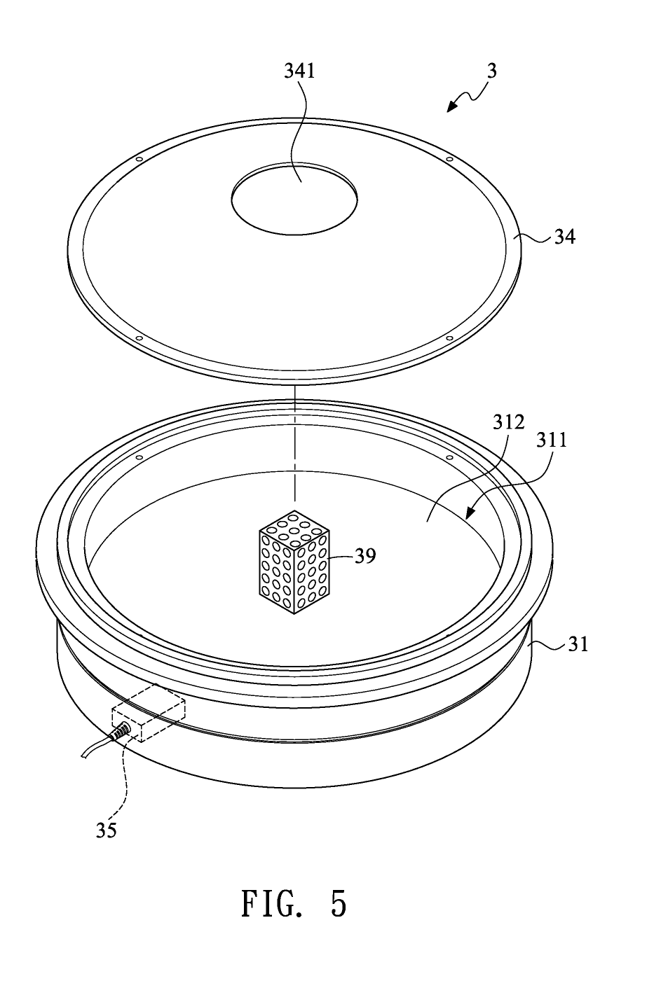

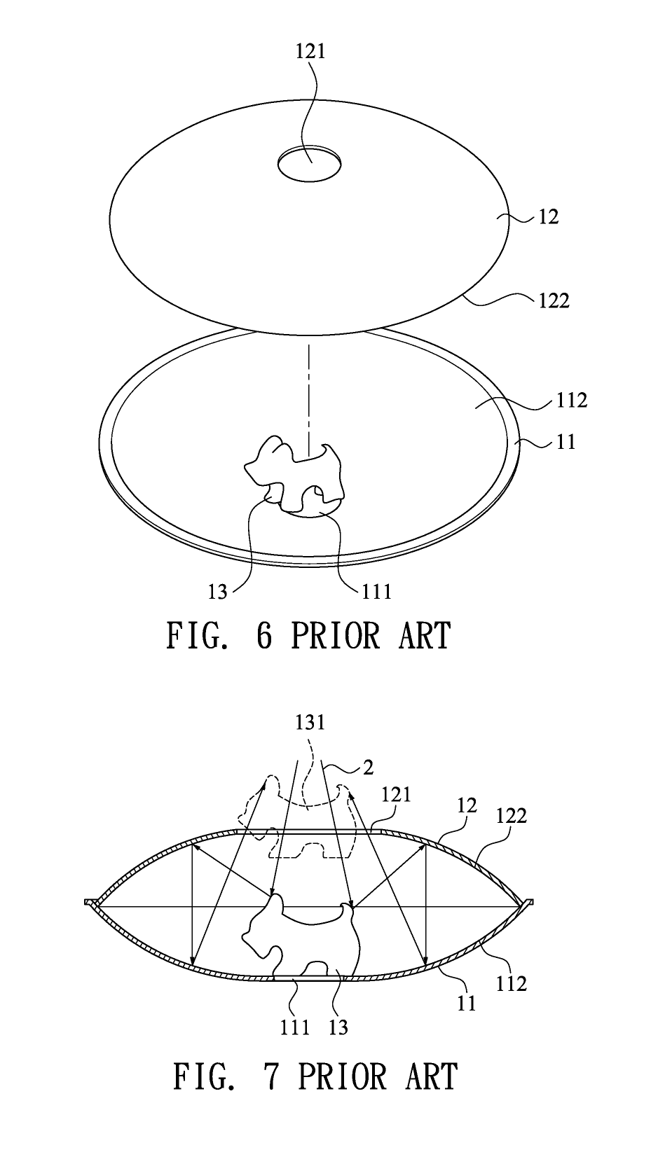

With reference to FIG. 5 for an illumination device capable of producing a floating image in accordance with a second preferred embodiment of the present invention, the illumination device 3 comes with a design that substitutes the light emitting module 32 and the object 33 by a self-luminous element 39. The self-luminous element 39 is provided for generating a light source, a message or an image. With the structure of the illumination device 3, the light source, message or image generated by the self-luminous element 39 is reflected and focused at the hole 341 to form the floating image 5.

This illumination device 3 includes elements identical to the aforementioned elements, and thus will not be described here again.

In summation of the description above, the present invention has the following advantages over the prior art:

1. The invention can effectively overcome the drawbacks of the conventional decorative item which is limited by the external light source by installing the light emitting module 32 at the central position of the reflective cavity 31, and generating the light source 4 in the reflective cavity 31 by using a light emitting module 32. As a result, the image of the object 33 can be reflected from the light reflector 34 onto the mirror 312 of reflective cavity 31 and focused at the hole 341 to form the floating image 5 without the issue of interference in the light source resulting from insufficient light intensity.

2. The invention can be applied to illumination lamps, since the light emitting module 32 is installed in the reflecting cavity 31, and the lamp reflector 34 has a form of being semi-transparent or transparent. The internal surface of the lamp reflector 34 can be a parabolic, non-spherical or a flat surface. The invention can be used for illumination lamps, in addition to the application of forming the floating image 5. To increase the brightness of the illumination lamps, the invention can add more light emitting modules 36 around the periphery of the reflecting cavity 31 to improve the light intensity.

3. The invention provides other functions by adding a control module 37 for controlling a timer for turning the illumination device 3 on or off, as well as controlling its axial rotation, brightness, and its music playing function. Control module 37 also generates the wireless control signal to control the operation of the illumination device 3.

Obviously, the present invention complies with patent application requirements, and thus is duly filed for patent application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An illumination device capable of producing a floating image, comprising:
a reflective cavity having an opening at one end and an internal surface which has a mirror;
a light emitting module, installed in the center of the reflective cavity, for generating a light source;
an object, placed on the light emitting module;
a light reflector, placed at the opening of the reflective cavity, this reflective cavity faces the mirrored surface And having a hole formed at a central position of the light reflector, corresponding to the light emitting module and the object; and
a power supply module, for supplying electric power to the light emitting module for generating the light source.

2. The illumination device capable of producing a floating image as recited in claim 1, wherein the power supply module is connected to an external power source for supplying the electric power to the light emitting module.

3. The illumination device capable of producing a floating image as recited in claim 1, wherein the mirror has a surface selected from a choice of a parabolic surface, a non-spherical or a flat surface.

4. The illumination device capable of producing a floating image as recited in claim 1, wherein the light emitting module is one selected from the collection of a monochrome LED component or a three-color LED element.

5. The illumination device capable of producing a floating image as recited in claim 1, wherein the object is one selected from the collection of a transparent object and a semi-transparent object.

6. The illumination device capable of producing a floating image as recited in claim 1, wherein the light reflector is one selected from a choice of a semi-transparent form or a transparent form, and the smooth internal surface of the lamp reflector has a surface selected from a choice of a parabolic, non-spherical or a flat surface.

7. The illumination device capable of producing a floating image as recited in claim 1, further comprising a remote control module, a control unit installed in the remote control module for controlling a timer for turning the illumination device on or off, as well as controlling axial rotation, blinking frequency, color temperature, illumination brightness, and the music playback function of the light emitting module.

8. The illumination device capable of producing a floating image as recited in claim 7, wherein the control unit generates a wireless control signal to control a timer for turning the illumination device on or off. The control unit also controls axial rotation, blinking frequency, color temperature, illumination brightness, and the music playing function of the light emitting module.

9. The illumination device capable of producing a floating image as recited in claim 1, further comprising multiple light emitting modules installed at the periphery around the reflective cavity to enhance the brightness of the illumination device.

10. An illumination device capable of producing a floating image, comprising:
a reflective cavity, having an opening located at one end of the reflective cavity, and a mirrored surface on the inside of the reflective cavity;
a self-luminous element, installed at a central position of the reflective cavity, for generating a light source;
a light reflector, installed at the opening of the reflective cavity and facing the mirror of the reflective cavity, and including a hole formed at a central position of the light reflector corresponding to the light emitting module and the object; and
a power supply module, for supplying electric power to the self-luminous element to generate the light source.

11. The illumination device capable of producing a floating image as recited in claim 10, wherein the power supply module is connected to an external power source and provided for supplying electric power to the light emitting module.

12. The illumination device capable of producing a floating image as recited in claim 10, wherein the mirror has a surface selected from a choice of a parabolic surface, a non-spherical surface or a flat surface.

13. The illumination device capable of producing a floating image as recited in claim 10, wherein the self-luminous element is chosen to be a monochrome LED element or a three-color LED element.

14. The illumination device capable of producing a floating image as recited in claim 10, wherein the self-luminous element further generates either a message or an image.

15. The illumination device capable of producing a floating image as recited in claim 10, wherein the light reflector is either in a semi-transparent form or a transparent form, and a smooth internal surface selected from a choice of a parabolic surface, a non-spherical surface or a flat surface.

16. The illumination device capable of producing a floating image as recited in claim 15, further comprising a remote control module and a control unit installed in the remote control module for controlling a timer for turning the illumination device on or off, as well as controlling axial rotation, blinking frequency, color temperature, illumination brightness, and the music playback function of the self-luminous element.

17. The illumination device capable of producing a floating image as recited in claim 16, wherein the control unit generates a wireless control signal for controlling a time setting of turning on or off the illumination device, an axial rotation, a blinking frequency, a color temperature, an illumination brightness, and a music playing function of the self-luminous element.

18. The illumination device capable of producing a floating image as recited in claim 10, further comprising a multitude of other light emitting modules installed around the periphery of the reflective cavity to enhance the brightness of the illumination device.
